(19) United States
(12) Patent Application Publication
(10) Pub. No.: US 2002/0029370 A1
(43) Pub. Date: Mar. 7, 2002

(54) Test case generator

(76) Inventors: Zbigniew Michalewicz, Charlotte, NC (US); Martin Schmidt, Charlotte, NC (US)

Correspondence Address: McGuire Woods, Suite 1800, 1750 Tysons Boulevard, McLean, VA, 22102-4215, US

(21) Appl. No.: 09/837,188

(22) Filed: Apr. 19, 2001

Related U.S. Application Data
(60) Provisional application No. 60/198,727, filed on Apr. 20, 2000.

(51) Int. Cl. G06F 17/50

(52) U.S. Cl. 716/4

(57) ABSTRACT

A test case generator which converts a real-world problem into an artificial landscape that preserves the main characteristics of the problem. A plurality of input parameters is used to define initial components of a feasibility space within a search space. The components are randomly enlarged and complexity is added. The results of a series of runs within the feasibility space are compared to arrive at a recommended optimization method. A computer program that runs on a workstation or personal computer implements the method of the invention. The test case generator can be applied to numerous types of problems.

### CROSS-REFERENCE TO RELATED APPLICATIONS

This application claims priority to U.S. Provisional Application Serial No. 60/198,727, filed on Apr. 20, 2000, the entire contents of which are herein incorporated by reference.

### BACKGROUND

1. Field of the Invention

The present invention is generally related to a system and method of generating test cases and more particularly, the present invention is related to a system and method for selecting a best optimization tool for solving a particular real-world problem using non-linear programming techniques.

2. Description of the Problem

Nonlinear programming is a technique that can be used to solve problems that can be put into a specific mathematical form. Specifically, nonlinear programming problems are solved by seeking to minimize a scalar function of several variables subject to other functions that serve to limit or define the values of the variables. These other functions are typically called constraints. The entire mathematical space of possible solutions to a problem is called the search space and is usually denoted by the letter “S”. The part of the search space in which the function to be minimized meets the constraints is called the feasibility space and is usually denoted by the letter “F”.

Nonlinear programming is a difficult field, and often many complexities must be conquered in order to arrive at a solution or “optimum” to a nonlinear programming problem. For example, some problems exhibit local “optima”; that is, some problems have spurious solutions that merely satisfy the requirements of the derivatives of the functions. However, nonlinear programming can be a powerful tool to solve complex real-world problems, assuming a problem can be characterized or sampled to determine the proper functions and parameters to be used in the nonlinear program.

Due to the complexity of nonlinear programming techniques, computers are often used to implement a nonlinear program. It should be noted that the term “programming” as used in the phrase “nonlinear programming” refers to the planning of the necessary solution steps that is part of the process of solving a particular problem. This choice of name is incidental to the use of the terms “program” and “programming” in reference to the list of instructions that is used to control the operation of a modem computer system. Thus, the term “NLP program” for nonlinear programming software is not a redundancy.

Almost any type of problem can be characterized in a way that allows it to be solved with the help of NLP techniques. This is because any abstract task to be accomplished can be thought of as solving a problem. The process of solving such a problem can, in turn, be perceived as a search through a space of potential solutions. Since one usually seeks the best solution, this task can be characterized as an optimization process. However, nonlinear programming techniques are especially useful for solving complex engineering problems. These techniques can also be used to solve problems in the field of operations research (OR) which is a professional discipline that deals with the application of information technology for informed decision-making.

The NLP problem has often been thought of as intractable; that is, the NLP problem is impossible to develop a deterministic method for the NLP in the global optimization category which would be better than an exhaustive search. It is not clear what characteristics of a problem make it difficult or easy for a particular nonlinear programming technique. However, it is known that any problem can be characterized by various parameters which may include, for example, the number of linear and nonlinear constraints; the number of variables; the number of active constraints at the optimum; the ratio (e.g., ρ=IFI/ISI) between the sizes of feasible search space and the whole search space; the type of the objective function; number of local optima; and many others. It is further known that different optimization techniques have different capabilities, with some techniques giving quality results on some problems while failing on other problems. Thus, one of the main difficulties encountered with nonlinear programming is to initially choose the best optimization tool to program the particular problem at hand. This problem exists whether a nonlinear program is run manually or on a computer system.

What is needed is a method that can be used to determine the best optimization technique for a particular class of problems. Ideally, such a method should lend itself to execution on a programmed computer system and should be capable of handling problems with different ratios of the sizes of the feasibility space to the search space as well as different numbers and types of constraints.

### SUMMARY

According to the invention, a method is executed in which a real-world problem is sampled to determine a plurality of input parameters including a feasibility, and a specified number of components for the feasibility space. The specified number of components is randomly created within the search space so that there is a specified minimum distance between components, and so that the components form a feasibility space having a substantially small size in relation to a search space size. Next, the components are randomly enlarged until the feasibility space is an intermediate size. In embodiment, the intermediate size may be greater than the substantially small size and less than the feasibility multiplied by the search space size. Complexity is added to the feasibility space to achieve a final size for the feasibility space. The final size, in embodiments may be substantially equal to the feasibility multiplied by the search space size. A series of runs are made within the feasibility space and the results of the runs are compared to arrive at a recommendation for the best optimization tool for the problem.

In most cases, each component of the feasibility space as initially created above will consist of an individual box or other known geometrical shape. The random enlarging of the feasibility space is, in embodiments, accomplished by repeatedly moving a side of a box. If a collision occurs, the move is undone so that collisions are avoided. Complexity is preferably added by repeatedly attaching new boxes to existing boxes so that at least some of the components of the feasibility space come to be made up of multiple boxes.

A specified complexity for the feasibility space is one of the input parameters. The intermediate size for the feasibility space is equal to the quantity one minus this specified complexity multiplied by the feasibility and in turn, the search space size. In the embodiments, the substantially small size is equal to of the intermediate size referred to above. When referring to quantities as being substantially equal, it is meant equal to within normal floating point or rounding imprecision, which may be imposed on a particular implementation of the method.

Preferably, a computer software program is used to implement the steps present invention; however, the steps may be implemented via a hardwired circuit or computer. The software can be stored on a media. The media can be magnetic such as diskette, tape, or fixed disc, or optical, such as a CD-ROM. Additionally, the software can be supplied via the Internees or some other type of network. A workstation or personal computer that typically runs the software includes a plurality of input/output devices and a system unit that includes both hardware and software necessary to provide the means to execute the method of the invention.

### BRIEF DESCRIPTION OF THE DRAWINGS

FIG. 1 is a high-level flow chart of the basic method of the present invention;

FIG. 2 is a flowchart showing the method of the present invention;

FIG. 3 shows an example of constraints generated by the method of the present invention;

FIG. 4 shows an example of constraints generated by the method of the present invention where the constraints are varied;

FIG. 5 shows an example of constraints generated by the method of the present invention where the complexity of the constraints has been increased;

FIG. 6 shows an example graph of constraint violation value as a function of distance to the closest center of feasible areas;

FIG. 7 shows an example objective function according to the present invention;

FIG. 8 shows a two-dimensional example of an objective function according to the present invention;

FIG. 9 shows another objective function according to the present invention;

FIG. 10 shows another constraint violation function according to the present invention;

FIG. 11 shows an example fitness function according to the present invention;

FIG. 12 shows a workstation on which the present invention may be implemented;

FIG. 13 shows further detail of the hardware that is used to execute the steps of the present invention; and

FIGS. 14-19 show various results using the method of the present invention.

### DETAILED DESCRIPTION

The present invention is directed to providing a test case generator used to determine the best optimization technique for a particular real-world problem. To determine the best optimization technique, a particular problem is analyzed and converted into an artificial landscape which preserves the main characteristics of the real problem. These characteristics include, for example, the number of linear and nonlinear constraints, the number of variables, the number of active constraints at the optimum, the ratio between the sizes of feasible search space and the whole search space, as well as the type of the objective function, number of local optima and the like. For convenience, the ratio between the sizes of feasible search space and the whole search space may be referred to as the “feasibility”. Experiments are performed with the generated landscape, and various techniques (with different parameters) and various components of these techniques (e.g., a component for constraint handling) are then examined to assist in the determination of the best optimization technique. During this stage, several factors may be taken into account including, but not limited to, the number of function evaluations; feasibility of the solution found; efficiency and the like. Finally, the system is capable in making an appropriate recommendation for the best method for a given problem.

Now to the particulars, the general nonlinear programming (NLP) problem is to find x so as to:

optimize f(\vec{x}), \vec{x}=(xₗ, . . . , xₗ) ∈ [symbol] ⁿ,

where \vec{x} ∈ F 532 [symbol] ⁿ. The objective function f is defined on the search space S ⊂ [symbol] ⁿ and the set F⊂S defines the feasible region. Usually, the search space S is defined as an n-dimensional rectangle in [symbol] ⁿ (domains of variables defined by their lower and upper bounds):

lᵢ≦xᵢ≦uᵢ, l≦i≦n,

where the feasible region F ⊂S is defined by a set of p additional constraints where p≧0:

gⱼ(\vec{x})≦0, for j =1 , . . . q, and hⱼ(x)=0, for j=q+1, . . . ,p.

At any point x ∈ F, the constraints gⱼ that satisfy gⱼ(x)=0 are called the active constraints at \vec{x}.

Now understanding the above, the test case generator (TCG) of the present invention is a parameterized test case generator of the following form:

TCG(n, m, ρ, c, a, p, σ, α, d),

where, in embodiments, the parameters control the following:

n → the dimensionality of the test function;

m → the number of feasible components;

ρ → the feasibility of the search space;

c → the complexity of the feasible search space;

a → the number of active constraints at global optimum;

p → the number of peaks of the objective function;

σ → the width of the peaks;

α → the decay of height of the peaks; and

d → the minimum distance between different components.

The ranges and the types of the parameters may include, for example,

1≦n; integer,

0≦c ≦1; float,

0≦σ; float,

1≦m; integer,

0≦a≦n; integer,

0≦α≦1; float,

0≦ρ≦1; float,

1≦p; integer,

0≦d≦1; float.

There are five major intermediate components determined by the TCG of the present invention in order to arrive at a recommendation. These components include:

1. The search space.

2. The feasible search space or the “feasibility space”.

3. The constraint violation function.

4. The landscape of the objective function.

5. The fitness landscape using a static penalty approach.

Search Space

The TCG of the present invention randomly creates non-overlapping feasible areas (referred to as boxes or other known geometrical shapes) in the search space. The search space is defined as an n-dimensional cube with a closed range [0,1]. It is further noted that many boxes are attached to each other in order to form feasible components, where all components are disjointed and hold a total feasible area of ρ * |S|. Note that the higher the complexity c is, the more (probably smaller) boxes will be created (hence the higher the complexity).

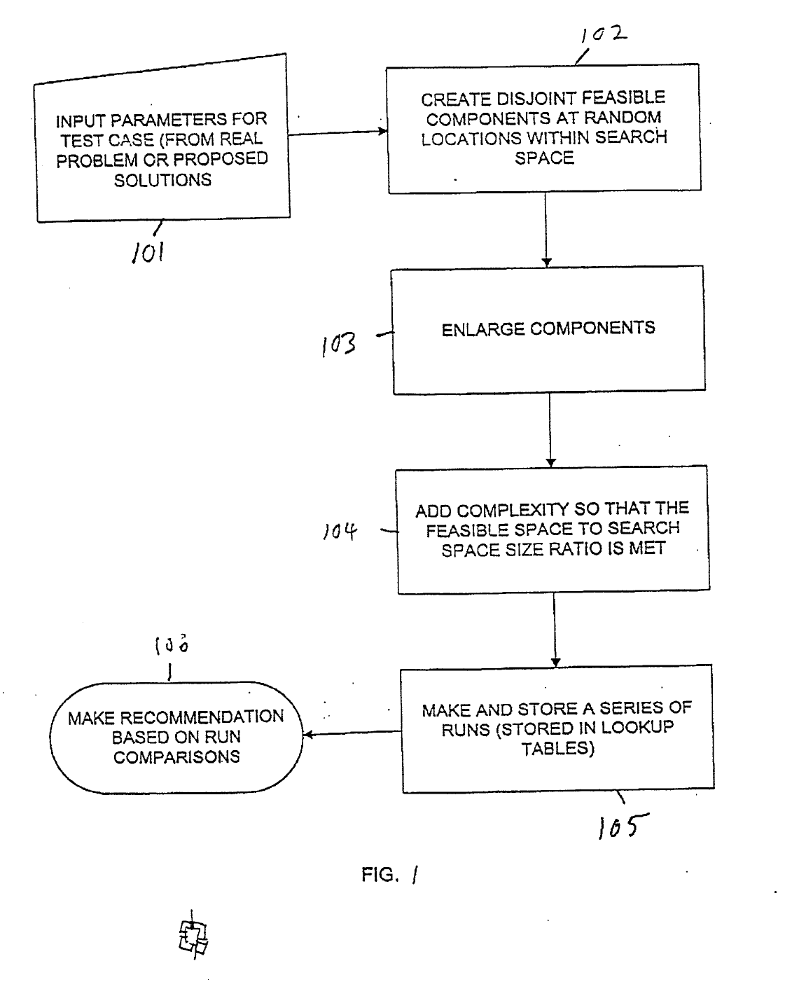

Referring now to the drawings, FIG. 1 is a flowchart showing the method of creating the feasible part of the search space for a real-world problem and a recommended solution to the problem in accordance with the present invention. FIG. 1 may equally represent a high level system diagram showing the system of the present invention.

At step 101, a real problem is sampled to determine the input parameters as discussed above. At step 102, m disjoint feasible components are created at random locations within the search space. These components initially consist of individual boxes, where each component occupies only a small fraction of the final, total, feasible search space. At step 103, the components are enlarged, although the total number of components remains m. At step 104, complexity is added until the final, desired, level of complexity c is achieved by the present invention. Finally, at step 105, a series of runs is made and the results are stored in lookup tables. At step 106, a recommendation is made by comparing the results of the runs made at step 105. It should thus be clear that the present invention is capable of (i) the generation of the feasible part of the search space which can perform the steps of creating initial components, (ii) enlarging the initial components, and (iii) adding complexity to the components until a feasibility space of an appropriate size has been created.

The sampling procedure estimates the characteristics of a real problem. Some of these are given, such as the number of variables while others are estimated based on the results of sampling (e.g., the number of feasible components, the feasibility ratio, the number of peaks, etc.). By way of example, consider the common engineering problem of mechanical component design. The characteristics of a cantilever beam, for example, may include the shape of the cross section, the length and other dimensions, as well as the specified material for constructing the beam. Constraints may include a specific length or range of lengths required for a given application, the amount of weight or load the beam must be able to bear and the cost of the beam. (Note that the total number of constraints corresponds to the input parameter a.) If the acceptable cost is high and the load is low, many different materials will suffice. A sampling of such a problem might produce a complex search space with many feasible areas, since, in fact, many different designs are literally feasible. However, if the cost must be low and the load high, few materials will probably suffice and the complexity and number of components in the search space might be low. The characteristics of the problem change if, for example, a specific material is desired for aesthetic reasons, but other components of the mechanical system are to be adapted to a beam of whatever size will work best. Sampling a specific problem produces an input array which takes the specific problem characteristics into account.

Feasibility Space

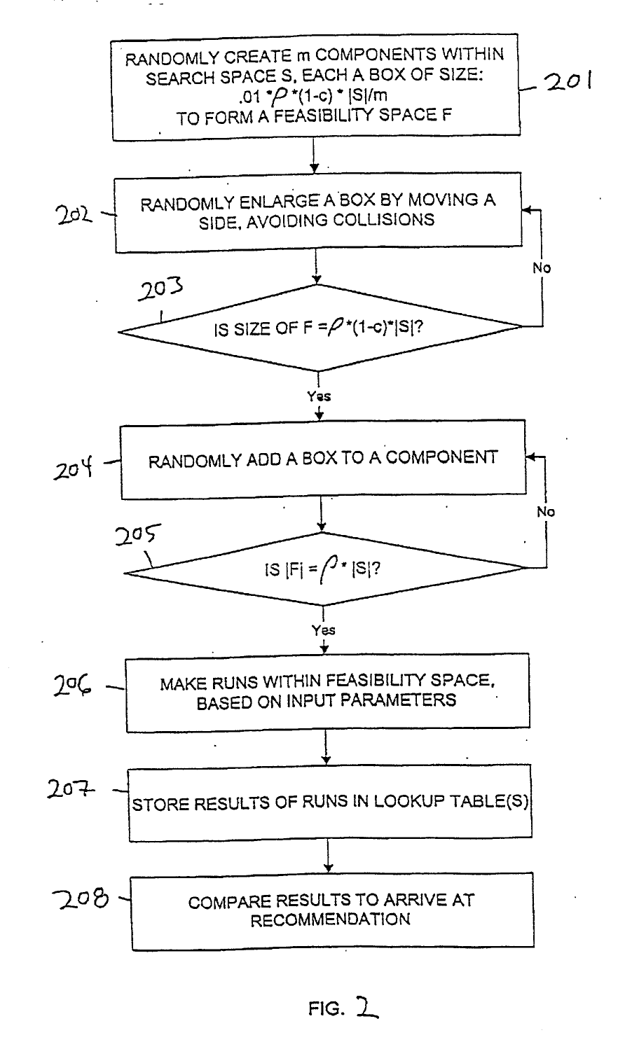

FIG. 2 is another flowchart illustrating the method (and high level system) of the present invention related to creating the feasibility space. At step 201, m components are created within the n—dimensional search space S to form a feasibility space F that has a substantially small size. Each component is a box of a size that is, in embodiments, one percent (0.01) of the feasibility ρ multiplied by one minus the complexity further multiplied by the size of the search space S divided by the total number of components m. Since there are m components, the total feasibility space size at this point is equal to one percent of the feasibility multiplied by one minus the complexity further multiplied by the search space size, that is, 0.01 * ρ *(1−c) * |S|.

At step 202, the sizes of the component boxes are enlarged by repeatedly and randomly moving a side of a box. If a collision occurs, the side is unmoved so that collisions are avoided. At step 203, the size is checked after each movement. The moving stops when the total size of the feasibility space reaches an intermediate size equal to the feasibility ρ times one minus the complexity, times the search space size, or simply, ρ * (1−c) * |S|. Finally, at step 203, complexity is added by repeatedly and randomly adding a box to a component so that at least some of the components are made up of multiple boxes. The minimal distance d is maintained during this step.

At step 205, the size of the feasibility space is checked until it is equal to the feasibility ratio ρtimes the size of the search space. If not, the process returns to step 204. The final feasibility space has now been defined. This procedure also assures that no matter how many boxes are added there will never be any feasible continuous path from one feasible component to any other feasible component. Hence, the present invention will provide m disconnected feasible components and every component consists of one or more boxes. It should be noted that the steps for randomly creating, enlarging, and adding complexity to the component boxes require as input m, ρ, and c so that the sizes of the feasibility space can be defined, and d so that the minimal distance between components is maintained. The other parameters serve as additional constraints for the method of the present invention as will become clear from the examples to follow.

Still referring to FIG. 2, at step 206, the method of the present invention makes runs within the feasibility space based on the input parameters. The results of the runs are stored in a lookup table or lookup tables at step 207. The results are then compared so that a recommendation can be made at 208. For a particular optimization method, a run is one or more executions of the steps of the present invention (to eliminate the noise in the case of stochastic algorithms) for a given set of input parameters. In other words, a run indicates the quality of performance of a method for a given set of input parameters. The results of all runs (i.e., for different settings of the input parameters) are stored in a lookup table which summarizes the knowledge of performance of various optimization methods on various settings of input parameters. For each method, and for every combination of parameter setting, there is a quality measure which is a real number (between zero and one) indicating the quality of the solution found (number one indicates the perfect solution).

Constraint Generation

All procedures generate different components such that the minimal distance between such components is d. Note that the constraint generation is stochastic. Therefore each procedure is designed such that it restarts if it gets stuck in an invalid arrangement of boxes. In general, if m>4 and ρ is close to 1 then the constraint generation has a long runtime since it is difficult to arrange the boxes correctly. In the extreme case of ρ=1 (and m>1) it is impossible to create disjoint components and hence a feasible arrangement of m components is impossible. Also, in the extreme case of a large feasibility ρ and a large minimal distance d may become impossible to generate a valid arrangement of boxes.

The results of the constraint generation are:

The larger the number of components m, the more (disconnected) feasible components are generated.

The larger the feasibility p, the larger the initial components are (as ρ * (1−c) * |S|/m), and the larger the final feasible search space becomes (as ρ * |S|).

The larger the complexity c, the smaller the initial components are (as ρ * (1−c) * |S|/m) and the more boxes are added to the components (as ρ * c * |S|). The more boxes that are added to the components, the more complex the feasible search space becomes. Hence, the larger the complexity c is the more complex and difficult the feasible search space becomes.

The larger the minimal distance d is the more separated the feasible components become, and hence they will form more and more separated feasible islands.

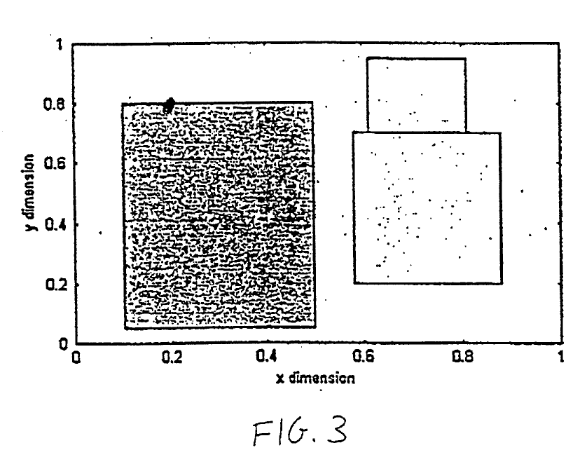

FIGS. 3-6 show examples of generated constraints in accordance with the present invention. More specifically, FIG. 3 presents generated constraints for TCG(n=2, m=2, ρ=0.5, c=0.1, a=1, p=3, σ=0.4, α=0.5, d=0.01) with two feasible components in agreement with m=2. The two different components are distinguished by crosshatching, and the rectangles illustrate the generated feasible boxes. The global optimum is indicated with a dot at (0.2,0.8) where there is one active constraint in agreement with a=1. The two largest boxes are generated by the procedures for creating initial components and enlarging initial components. Since ρ=0.5 and c=0, the size of the initial components (the two largest boxes in this case) is ρ * (1−c) * |S|=0.45. All other boxes (in this case only the third box around the location (0.7,0.9)) are created using the procedure for adding complexity so that the total size of the added boxes is ρ* c * |S|=0.05 and the total size of the feasible components is ρ * |S|=0.5.

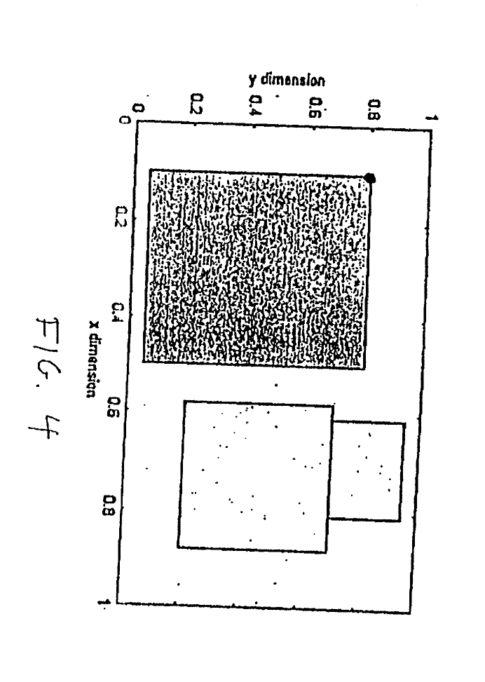

FIG. 4 shows the impact of varying the number of active constraints a. In the example, of FIG. 4 the generated constraints for TCG(n=2, m=2, ρ=0.5, c=0.1, a=2,p=3, σ=0.4, α=0.5, d=0.01). In this example, there are two active constraints (not just one as in FIG. 3) at the global optimum at (0.1,0.8) in agreement with a=2. Hence, the difference between FIG. 3 and FIG. 4 is that the global optimum is placed differently according to a=1 and a=2, respectively. The total size of the feasible search space is the same in FIG. 4 as in FIG. 3 since ρ=0.5.

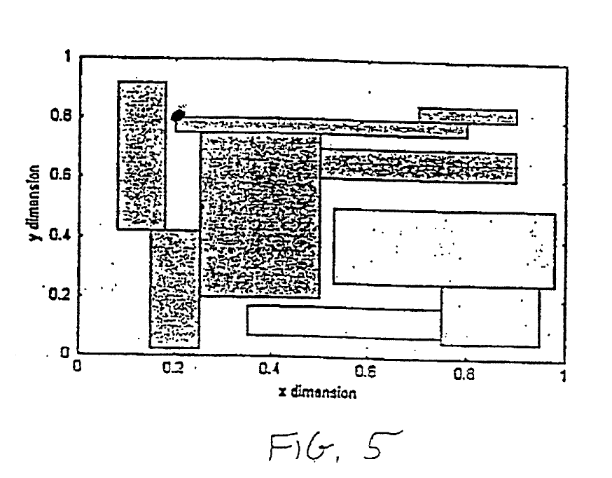

FIG. 5 shows an example of constraints generated by the method of the present invention where the complexity of the constraints are increased. That is, FIG. 5 shows the case for TCG(n=2, m=2, ρ=0.5, c=0.5, a=2,p=3, σ=0.4, α=0.5, d=0.01). Note that since c=0.5, the complexity is larger than in the earlier examples. In FIG. 5, the global optimum is placed such that there are two active constraints at the global optimum at (0.2,0.8) in agreement with a =2. Also, FIG. 5 clearly shows the impact of the complexity c where the initial boxes become smaller as the complexity c becomes larger. It is noted that the larger the complexity c the more boxes are added. In this manner, the search space literally becomes more complex. Note that the size of the two feasible components is different and that a different number of boxes are attached to the two components. Further, all boxes that belong to the same component are attached to each other but they do not overlap. Boxes that belong to different components are disconnected.

Constraint Violation Function

Based on the created feasible components, a constraint violation function can be defined by the present invention. Inside the feasible boxes the constraint violation value is zero and outside the feasible boxes the constraint violation value is the distance to the closest center of all feasible boxes. The center of a feasible box is simply the middle of the box. The following formula shows the constraint violation function CV(\vec{x}):

$$CV ( \vec{x} ) = \{ \begin{matrix}0 & if \vec{x} is inside the a box , \\ \vert {\vec{c}}_{box} - \vec{x} \vert & otherwise\end{matrix}$$

where \vec{c}_{box} is the closest center of the feasible boxes and \vec{x} is the vector to evaluate.

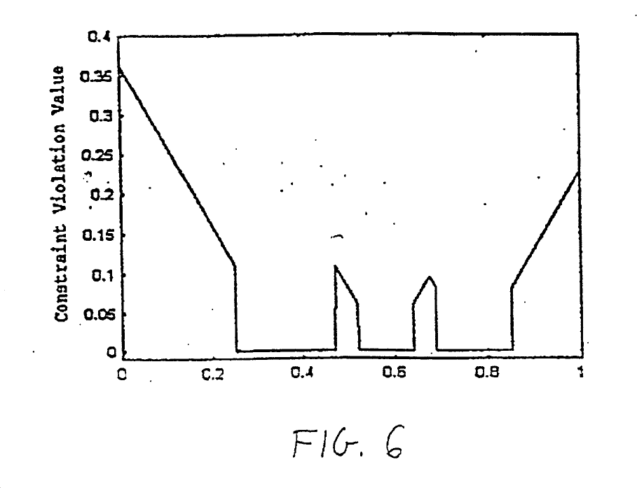

FIG. 6 shows an example with three feasible components, (i.e. m=3). More specifically, FIG. 6 shows three feasible areas (approximately 0.4, approximately 0.6, and approximately 0.8) and the constraint violation value as a function of the distance to the closest center of the feasible areas. The constraint violation function is responsible for penalizing infeasible solutions. As a result, feasible solutions rate better than infeasible solutions (in terms of their fitness). Consequently, the constraint violation function is used as a “dragging term” (or “forcing component” or “additional measure”), encouraging infeasible solutions to move closer to the feasible area of the search space.

Objective Function

After the creation of the feasible components the objective function G(\vec{x}) is defined as:

$$G ( \vec{x} ) = {g}_{i} ( \vec{x} ) where {∀}_{j} : \vert \vec{x} - {\vec{c}}_{i} \vert \leq \vert \vec{x} - {\vec{c}}_{j} \vert , and where$$

$${g}_{k} ( \vec{x} ) = {h}_{k} exp ( - \frac{{\vert \vec{x} - {\vec{c}}_{k} \vert}^{2}}{2 {σ}^{2}} ) ⋀ α \leq {h}_{k} \leq 1 ⋀ k = 1 , … , p .$$

The above equation defines the objective function G(\vec{x}) using a set of p randomly placed gaussians gₖ (\vec{x}) where hₖ is the height of peak k and \vec{c}ₖ is the center of peak k. In order to evaluate G(\vec{x}), the closest center \vec{c}ᵢ is found and then the function gᵢ (\vec{x}) is evaluated. The reason for this approach is to create a non-differentiable and disruptive landscape for the objective function. All centers \vec{c}ₖ are placed randomly in the search space with the exception of the global optimum that is placed such that there are exactly a active constraints at the global optimum. The centers are placed randomly in order to be able to create constraint optimization problems with certain features but with no specific locations of centers. This technique also reduces the number of parameters. All peak heights hₖ are evenly distributed in the range [α,1] such that the global optimum has the highest peak hₖ=1 while the lowest peak has the height hₖ=α. Note that the global optimum is always placed either inside a feasible area (if a=0) or at the border of a box (if a>0). Hence the feasible global optimum always has the value G(\vec{x})=1.0 and the constraint violation value CV(\vec{x}0)=0.

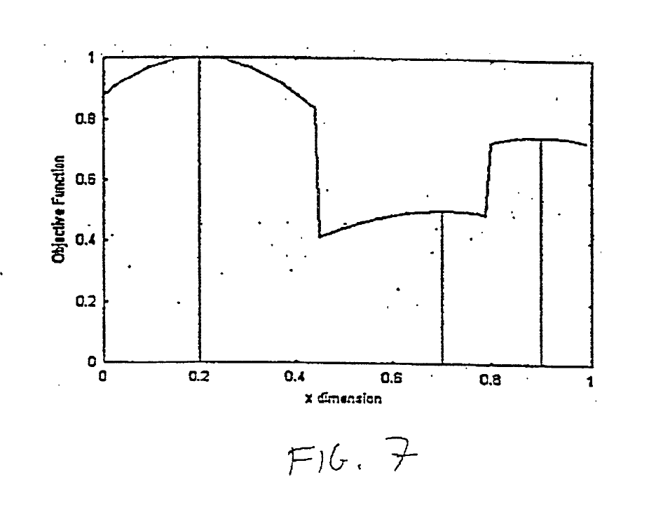

FIG. 7 shows a one-dimensional example of the objective function G(\vec{x}) for TCG(n=1, m=2, ρ=0.5, c=0.5, a=1, p=3, σ=0.4, α=0.5, d=0.01). Note that m, ρ, c and a have no impact on the objective function, except at the location of the global optimum which is located such that there are a active constraints. FIG. 7 shows the objective function G(\vec{x}) and the vertical lines indicate the 3 peaks in agreement with p=3. Notice that the global peak is at x=0.2 and that the objective function is non-differentiable and disruptive between the centers of the peaks. At x=0.7 the lowest peak is located with the height hₖ=α=0.5.

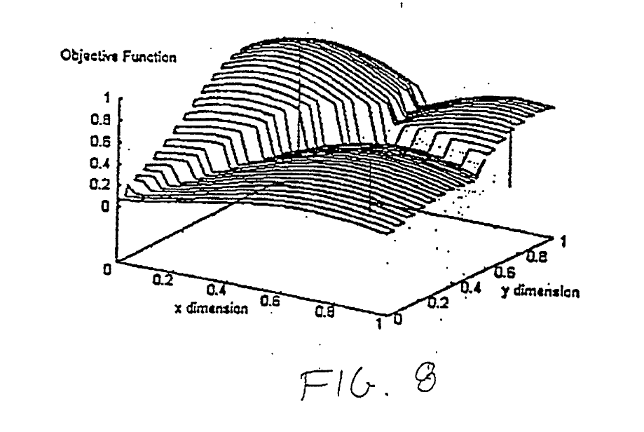

FIG. 8 shows a two-dimensional example of the objective function G(\vec{x}) for TCG(n=2, m=2, ρ=0.5, c=0.5, a=2,p=3, σ=0.4, α=0.5, d=0.01), where there are three peaks in agreement with p=3. The global optimum is at (0.2,0.8) with the height hₖ=1.0 and the lowest peak is at (0.7,0.4) with the height hₖ=α=0.5. Notice the disruptive surface of the objective function and the irregular arrangement of the peaks.

Static Penalty Approach

The static penalty approach uses the objective function G(\vec{x}) and constraint violation function CV(\vec{x}), and combines them as follows:

fitness(\vec{x})=G(\vec{x})−W * CV(\vec{x})

where penalty constant W>0.

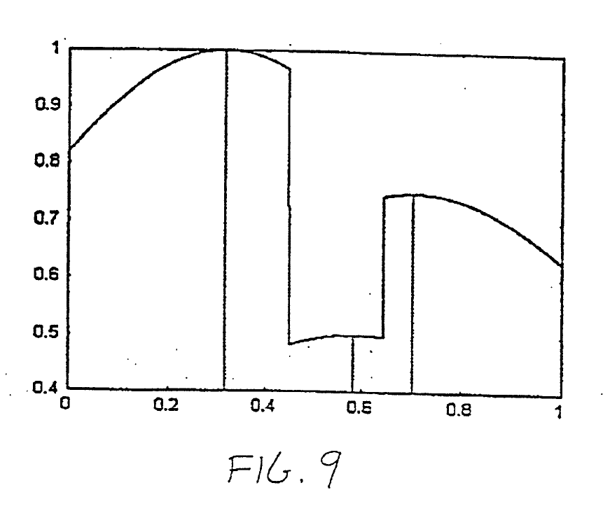

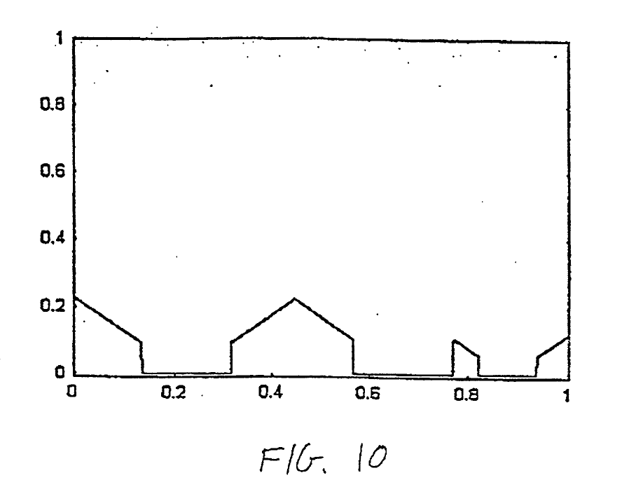

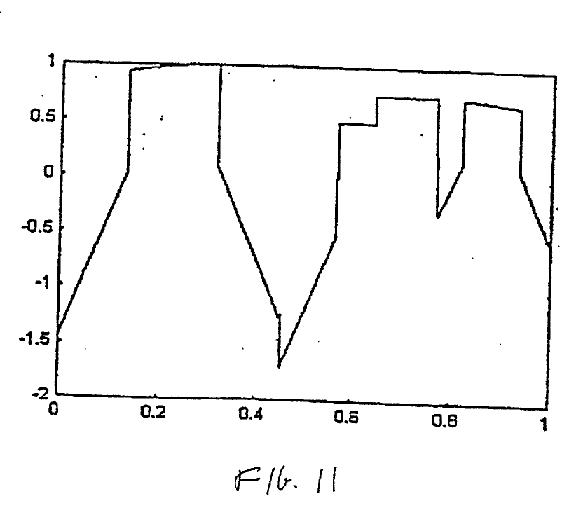

FIGS. 9 shows an example of a generated objective function. FIG. 10 shows a constraint violation function and FIG. 11 shows the resulting fitness landscape according to the present invention for TCG(n=l, m=3, ρ=0.5, c=0.0, a=1, p=3, σ=0.5, α=0.5, d=0.05) and for W=10. The resulting fitness landscape is multimodal with three feasible islands according to m=3. Note that the global peak (around 0.3) is located at the edge of the left-most feasible box which is as expected with a=1, i.e., one active constraint at the global optimum.

The TCG of the present invention has numerous advantageous characteristics that can be observed by studying the previous examples. The TCG according to the present invention has a precise and gradual control over the number of peaks p, and also has a direct and intuitive control over the feasibility of the search space with the parameter ρ. Since the constraint generation and the objective functions are separated from each other (except at the global optimum), side effects of varying the feasibility are eliminated with the present invention. Further, the feasible search space becomes one connected feasible component when the feasibility becomes large. The TCG of the present invention also exhibits a linear decay of the peaks that avoids problems caused by an exponential decay of the peaks, which causes far more low peaks than high peaks.

The TCG of the present invention also controls the number of active constraints a at the global optimum in a precise and gradual fashion. With this parameter, it is possible to test the ability of an optimizer to find the global optimum in spite of a varying number of active constraints at the global optimum. The TCG also exhibits a direct and gradual control over the number of disconnected feasible components using the parameter m. This control makes it possible to control how many feasible islands exist in the search space. As well as making it possible to investigate what impact the number of components has on a particular optimization technique.

Because the TCG has control over the complexity of the feasible search space using the parameter c, it is also possible to test an optimizer on search spaces with varying complexity without affecting any other parameters of the search space. The TCG of the present invention also controls the minimal distance d between feasible components. Note that increasing d generates more separated components that form more isolated islands. This control makes it possible to test the ability of optimizers to avoid getting stuck in isolated islands. By knowing the advantages or disadvantages of several optimization techniques with respect to complexity of the feasible search space (parameter c) and the number of active constraints (parameter a), then, for a given real-world problem (with estimated values of c and a), it is now possible to easily select the best method for the problem. As an example, assume there are two optimization methods M1 and M2, and the latter method provides much better results for higher values of parameter c but the former method is better for smaller values of parameter c. Now, there is a new real-world problem (e.g., complex structural design). Sampling determined that the feasible search space is quite complex (high values of c) and hence method M2 should be used on this problem.

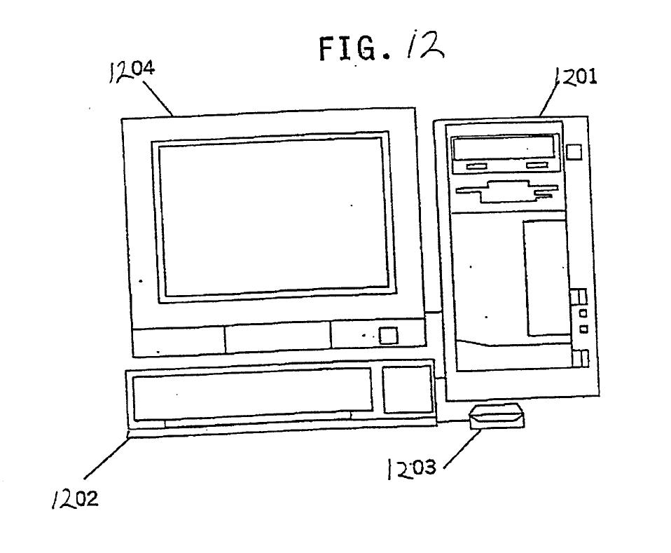

It is convenient to execute the method of the present invention on a computer system which has been programmed with appropriate software. The method of the present invention can equally be hardwired into a circuit or a computer system. FIG. 12 shows a workstation on which the steps of the present invention can be executed. Input/output (I/O) devices such as keyboard 1202, mouse 1203 and display 1204 are used by an operator to provide input and view information related to the operation of the present invention. System unit 1201 is connected to all of the I/O devices and contains memory, media devices, and a central processing unit (CPU), all of which together may execute the method of the present invention. Computer program code in combination with the appropriate hardware may also be used to implement the method of the present invention invention. This computer program code is often stored on storage media such as a diskette, hard disk, CD-ROM, DVD-ROM or tape, as well as a memory storage device or collection of memory storage devices such a read-only memory (ROM) or random access memory (RAM). Additionally, the computer program code can be transferred to a workstation over the Internees or some other type of network.

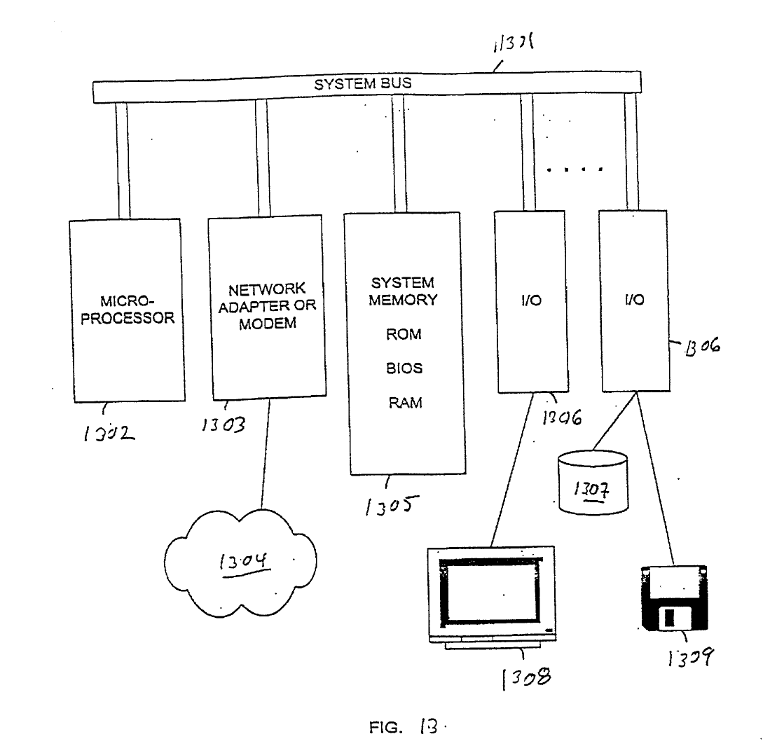

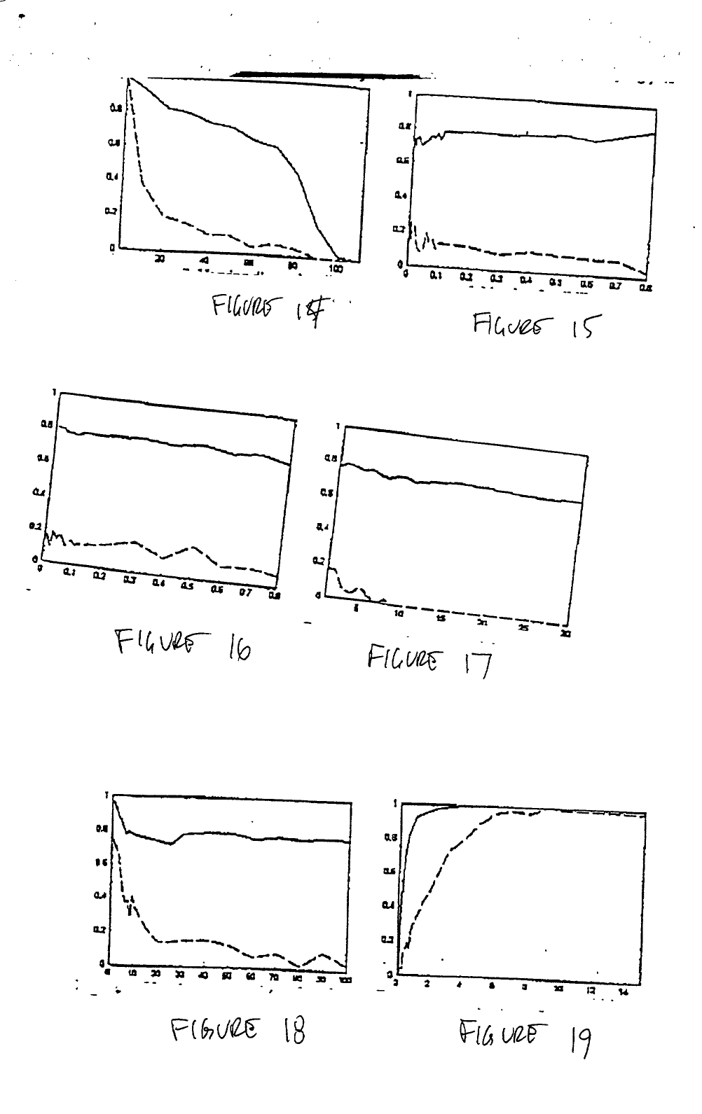

FIG. 13 shows the system unit for the computer system shown in FIG. 12. In FIG. 13, a system bus 1301 interconnects the major components. The system is controlled by microprocessor 1302 which serves as the CPU for the system. A system memory 1305 is typically divided into multiple types of memory or memory areas, such as read-only memory (ROM), random-access memory (RAM) and others. If the workstation is an IBM compatible personal computer, the system memory also contains a basic input/output system (BIOS). A plurality of general input/output (I/O) devices 1306 connect to various devices including a fixed disk 1307, a diskette drive 1309 and a display 1308. A system may include another I/O device, a network adapter or modem, shown at 1303, for connection to a network 1304. This network connection may be used to download the steps implementing the present invention for execution on the computer system. It should be noted that the system shown in FIGS. 12 and 14 is merely illustrative of a single example which may be used to implement the present invention and that those of ordinary skill will realize that other systems can equally be used to implement the steps of the present invention. Available systems include those that run operating systems such as Windows™ by Microsoft and various versions of UNIX, to name but a few.

Experimental Results

To test the usefulness of the TCG of the present invention, a constant population size of 100 was used and each individual was a vector \vec{x}of n floating point components. Parent selection was performed by a standard binary tournament selection, and an offspring replaced the worse individual of a binary tournament. One of the three operators was used in every generation (the selection of an operator was performed according to constant probabilities 0.5, 0.15 and 0.35 respectively):

Guassian mutation: for experiments used herein.

Uniform crossover: \vec{x}=(zₗ . . . zₙ), where each zₗ is either xᵢ or yᵢ (with equal probability), where \vec{x} and y are two selected parents and z is the child.

Heuristic crossover: z=r^{*}(\vec{x}−y)+y, where r is a uniform random number between 0 and 0.25,m and the parent \vec{x} is not worse than y.

The termination condition was to quit the loop if an improvement in the last N=10,000 generations was smaller than a predefined ε=0.0001. Now, the TCG of the present invention can be used to investigate the merits of any constraint handling method, e.g., for the popular constraint handling method based on static penalties.

The following results are averaged over 100 runs, and in each of the FIGS. 14-19 the continuos line shows the average fitness of the best final individual and the broken line shows how often the global optimum was reached. For discussion purposes, a single point from space TCG (n=30, m=3, ρ=0.1, c=0.5, a=1, p=3, σ=0.5, α=0.1, d=0.05) is discussed herein with one parameter varied at a time. Note that the lowest peak has a height of 0.1 and that all peaks may be placed in the infeasible space (except for the global optimum).

FIG. 14 shows TCG (n, m=3, ρ=0.1, c=0.5, a=1,p=3, σ=0.5, α=0.1, d=0.05) where the dimension n is varied between 1 and 110. As n is increased, a sudden decrease of performance (continuous line) occurs at about n=70. The probability for reaching the global optimum (broken line) drops significantly faster in this example.

FIG. 15 shows TCG (n=30, m=3, ρ, c=0.5, a=1, p=3, σ=0.5, α=0.1, d=0.05) where the dimension ρ is varied between 0.0001 and 0.8. As ρ is increased, a seemingly strange effect become visible; that is, the chance of finding the global optimum decreases as the feasibility ρ increases. This is because a step of the present invention may, in instances, become stuck in the feasible local optimum since more and more peaks are placed nearby a feasible area. The overall effect of a varying ρ is smaller than for a varying dimensionality n.

FIG. 16 shows TCG (n=30, m=3, ρ=0.1, c, a=1, p=3, σ=0.5, α=0.1, d=0.05), where the dimension c is varied between 0 and 0.8. As c is increased, both the performance and the chance for reaching the global optimum decreases, but the overall impact is relatively small and comparable to the impact of varying the feasibility σ.

FIG. 17 shows TCG (n=30, m=3, ρ=0.1, c=0.5, a, p=3, σ=0.5, α=0.1, d=0.05) where the dimension a is varied between 1 and 30 (note that a≦n and n=30). As a is increased, the performance slightly decreases and the change of reaching a global optimum drops to zero at about a=10. Thus, if a is increased it may, in instances, be more difficult to reach a global optimum (but other peaks may still be found with good performance).

FIG. 18 shows TCG (n=30, m=3, ρ=0.1, c=0.5, a=1, p, σ=0.5, α=0.1, d=0.05), where the dimension p is varied between 1 and 100. The chance of reaching the global optimum decreases as p increases. It is also noted that the performance decreases until p reaches 25, but then the performance increases and begins to stabilize. The reason for the behavior is based on the following:

p is small (in the case p≦25): When p is increased, the TCG of the present invention more easily becomes stuck in a poor local optimum.

p is large (in the case of p≧30): When p is increased, more good peaks are located in or nearby the feasibility areas and hence the TCG of the present invention more frequently finds the better solution. Further, asp increases there are also more good local peaks based on the linear decay of the peaks.

FIG. 19 shows TCG (n=30, m=3, ρ=0.1, c=0.5, a=1, p=3, σ, α=0.1, d=0.05), where the dimension σ is varied between 0.01 and 15. As expected, increasing σ (when σ is relatively small) increases the performance and the chance of reaching the global optimum. Nevertheless, increasing σ even further continues to increase the performance and the chance of reaching the global optimum. This happens since individuals that get into the feasible area around the global peak are assigned an objective value close to 1.0, which is larger than any peak. On the other hand, when σ is relatively small the individuals that are close to the local optima can receive a better fitness than the individuals close to the global optimum.

Example of Use

The following is an example provided for illustrative purposes only. This example, in no way, should be construed as a limiting feature of the present invention.

In this example, a certain corporation is planning to produce and market five different products. In this example, let xᵢ(for i=1, . . . ,5) denote the number of units to be produced of the five respective products. The preliminary estimates of the companies potential profitability are as follows:

For the first 150 units produced of product #1, the unit profit would be approximately $12.00. The unit profit would be $18.00 for any additional units of this product.

For the first 100 units produced of product #2, the unit profit would be approximately $8.00. The unit profit would be $15.00 for any additional units of this product.

For the first 80 units produced of product #3, the unit profit would be approximately $10.00. The unit profit would be $14.00 for any additional units of this product.

For the first 200 units produced of product #4, the unit profit would be approximately $11.00. The unit profit would be $12.00 for any additional units of this product.

For the first 100 units produced of product #5, the unit profit would be approximately $10.00. The unit profit would be $15.00 for any additional units of this product up to 200 units. For further units of this product, the unit profit would be $20.00 up to 500 units. Additional units would generate a unit profit of $25.00.

However, there are certain limitations on the use of needed resources. The production of each unit of the product i requires some material and some number of hours processing time on a special machine. The limitations are given in the following table.

| Product i | Amount of material | Number of hours |
|---|---|---|
| 1 | 30 | 5 |
| 2 | 100 | 11 |
| 3 | 45 | 2 |
| 4 | 66 | 8 |
| 5 | 20 | 5 |

The total available time is 1000 hours and the total available material is 150,000.

Now, management wants to know what value of xi should be chosen so as to maximize the total profit. This solution can be modeled by the present invention in the following manner.

Providing 5 problem variables, xᵢ to x₅

Defining the objective function as:

P(i₁,i₂,i₃,i₄,i₅)=p(i₁)+p(i₂)+p(i₃)+p(i₄)+p(i₅),

wherein:

$$p ( {x}_{1} ) = \{ \begin{matrix}12 {x}_{1} & if {x}_{1} \leq 150 \\ 1800 + 18 ( {x}_{1} - 150 ) & if 150 < {x}_{1}\end{matrix} \\ p ( {x}_{2} ) = \{ \begin{matrix}12 {x}_{2} & if {x}_{2} \leq 100 \\ 800 + 15 ( {x}_{2} - 100 ) & if 100 < {x}_{2}\end{matrix} \\ p ( {x}_{3} ) = \{ \begin{matrix}10 {x}_{3} & if {x}_{3} \leq 80 \\ 800 + 14 ( {x}_{3} - 80 ) & if 80 < {x}_{2} \leq 200 \\ 2480 + 12 + 20 ( {x}_{3} - 200 ) & if 200 < {x}_{3}\end{matrix} \\ p ( {x}_{4} ) = \{ \begin{matrix}11 {x}_{1} & if {x}_{4} \leq 200 \\ 2200 + 12 ( {x}_{4} - 200 ) & if 200 < {x}_{4}\end{matrix} \\ p ( {x}_{5} ) = \{ \begin{matrix}10 {x}_{5} & if {x}_{5} \leq 100 \\ 1000 + 15 ( {x}_{5} - 100 ) & if 100 < {x}_{5} \leq 200 \\ 2500 + 20 ( {x}_{5} - 200 ) & if 200 < {x}_{4} \leq 500 \\ 8500 + 25 ( {x}_{5} - 500 ) & if 200 {Mx}_{5} \leq 500\end{matrix}$$

Now, limitations (constraits) can be modelled as follow:

30i₁+100i₂+45i₃+66i₄+20i₅≦150000 (material limitation), and

5i₁+11i₂+2i₃+8i₄+6i₅≦1000 (time limitation).

At this stage, the nonlinear programming tool can be used to find the optimum solution.

It cannot be overemphasized that the practical applications of the present invention are almost unlimited. The applications may include structural design solutions as well as, for example, flaw detection in engineered structures; multiprocessor scheduling in computer networks; physical design of integrated circuits; scheduling activities; radar imaging and mass customization.

Conclusion

By using the system and method of the present invention, any real-world problem can be sampled. For example, by generating many random points in the search space and by checking their feasibility, it is possible to estimate the size of the feasible search space (with respect to the whole search space) and the total number of local optima. Also, by considering line segments between pairs of points, the present invention can estimate the number of disjoint components of the feasible search space and the complexity measure of the search space. Similarly, the width and the decay of heights of peaks of an objective function can be estimated by the present invention. Also, a vector of input parameters for the test case generator is the required result of the sampling procedure.

With the above noted, the TCG of the present invention always finds a feasible solution (even though the fitness may be close to zero). This is accomplished by creating nonlinear constrained optimization problems by means of easily adjustable parameters. Using the parameters, it is shown that the method and system of the present invention can control the dimensionality, the multimodality, the feasibility, the ruggedness, the constraintness, the feasibility components, the complexity of the search space and the separation of feasible islands. With this gradual and intuitive control over these parameters, the method and system of the present invention is a significant improvement over prior art systems.

It is further shown that that the largest impact on the performance and the chance for reaching the global optimum is found by varying the parameters, in order, the dimensionality n, the width of the peaks p; and the number of peaks p. In general, varying the feasibility ρ, the complexity c or the number of active constraints a seemed to have relatively little effect on the performance of the present invention.

While the invention has been described in terms of several embodiments, those skilled in the art will recognize that the invention can be practiced with modification within the spirit and scope of the appended claims. The following claims are in no way intended to limit the scope of the invention to specific embodiments.

1. A method of selecting an optimization tool for solving a problem, the method comprising the steps of:
sampling the problem to determine a plurality of input parameters including a feasibility and a specified number of components for a feasibility space;
randomly creating the specified number of components within a search space so that the components form the feasibility space having a substantially small size in relation to a search space size;
randomly enlarging the components while avoiding collisions until the feasibility space is an intermediate size;
adding complexity to the feasibility space to achieve a final size for the feasibility space; and
making a series of runs within the feasibility space and comparing results from the series of runs to select the optimization tool.

2. The method of claim 1, wherein the final size for the feasibility space is substantially equal to the feasibility multiplied by the search space size.

3. The method of claim 1, wherein the specified number of components have a specified minimal distance between different components within the search space

4. The method of claim 1, wherein the intermediate size is greater than the substantially small size and less than the feasibility multiplied by the search space size.

5. The method of claim 1, wherein before the randomly enlarging step and after the randomly creating step each component consists of one box, and the randomly enlarging step is accomplished by repeatedly moving a side of any box and the adding complexity step is accomplished by repeatedly creating and attaching a new box to any existing box so that at least one component includes more than one box.

6. The method of claim 5, wherein the plurality of input parameters further includes a specified complexity, and the intermediate size is substantially equal to the feasibility multiplied by a result equal to one minus the specified complexity, further multiplied by the search space size.

7. The method of claim 1, wherein the plurality of input parameters further includes a specified complexity, and the intermediate size is a value substantially equal to the feasibility multiplied by a result equal to one minus the specified complexity, further multiplied by the search space size.

8. The method of claim 7, wherein the substantially small size is substantially equal to one percent of the feasibility multiplied by a result equal to one minus the specified complexity, further multiplied by the search space size.

9. A method of selecting an optimization tool for solving a problem, the method comprising the steps of:
sampling the problem to determine a plurality of input parameters including a feasibility and a specified number of components for a feasibility space;
randomly creating the specified number of components having a specified minimal distance between different components within a search space so that the components form the feasibility space having a substantially small size in relation to a search space size, the components being represented by a predefined geometrical shape;
randomly enlarging the components while avoiding collisions until the feasibility space is an intermediate size that is greater than the substantially small size and less than the feasibility multiplied by the search space size;
adding complexity to the feasibility space to achieve a final size for the feasibility space that is substantially equal to the feasibility multiplied by the search space size; and
making a series of runs within the feasibility space and comparing results from the series of runs to select the optimization tool.

10. The method of claim 9, wherein the predefined geometrical shape is a box which includes sides which are moved during the randomly enlarging step.

11. The method of claim 10, wherein the adding complexity step includes creating and attaching a new box to any existing box so that at least one component includes more than one box.

12. The method of claim 10, wherein the plurality of input parameters further includes a specified complexity, and the intermediate size is substantially equal to the feasibility multiplied by a result equal to one minus the specified complexity, further multiplied by the search space size.

13. The method of claim 9, wherein the plurality of input parameters further includes a specified complexity, and the substantially small size is substantially equal to one percent of the feasibility multiplied by a result equal to one minus the specified complexity, further multiplied by the search space size.

14. An apparatus for selecting an optimization tool for solving a problem that has been sampled to determine a plurality of input parameters including a feasibility and a specified number of components, the method comprising the steps of:
means for sampling the problem to determine a plurality of input parameters including a feasibility and a specified number of components for a feasibility space;
means for randomly creating the specified number of components within a search space so that the components form the feasibility space having a substantially small size in relation to a search space size;
means for randomly enlarging the components while avoiding collisions until the feasibility space is an intermediate size;
means for adding complexity to the feasibility space to achieve a final size for the feasibility space; and
means for making a series of runs within the feasibility space and comparing results from the series of runs to select the optimization tool.

15. The apparatus of claim 14, wherein the final size for the feasibility space is substantially equal to the feasibility multiplied by the search space size.

16. The apparatus of claim 14, wherein the specified number of components have a specified minimal distance between different components within the search space

17. The apparatus of claim 14, wherein the intermediate size is greater than the substantially small size and less than the feasibility multiplied by the search space size.

18. A computer program product for enabling a computer system to select an optimization tool for solving a problem that has been sampled to determine a plurality of input parameters including a feasibility and a specified number of components, the computer program product including a medium with a computer program embodied thereon, the computer program comprising:
computer program code for randomly creating the specified number of components having a specified minimal distance between different components within a search space, so that the components form a feasibility space having a substantially small size in relation to a search space size;
computer program code for randomly enlarging the components while avoiding collisions until the feasibility space is an intermediate size that is greater than the substantially small size and less than the feasibility multiplied by the search space size;
computer program code for adding complexity to the feasibility space to achieve a final size for the feasibility space that is substantially equal to the feasibility multiplied by the search space size; and
computer program code for making a series of runs within the feasibility space and comparing results from the series of runs to select the optimization tool.

19. The computer program product of claim 18, wherein before executing the computer program code for randomly enlarging and after executing the computer program code for randomly creating the specified number of components, each component consists of one box, and furthermore:
the computer program code for randomly enlarging repeatedly moves a side of any box; and
the computer program code for adding complexity repeatedly creates and attaches a new box to any existing box so that at least one component includes more than one box.

20. The computer program product of claim 18, wherein the plurality of input parameters further includes a specified complexity, and the intermediate size is substantially equal to the feasibility multiplied by a result equal to one minus the specified complexity, further multiplied by the search space size.

21. The computer program product of claim 19, wherein the plurality of input parameters further includes a specified complexity, and the intermediate size is a value substantially equal to the feasibility multiplied by a result equal to one minus the specified complexity, further multiplied by the search space size.

22. The computer program product of claim 18, wherein the plurality of input parameters further includes a specified complexity, and the substantially small size is substantially equal to one percent of the feasibility multiplied by a result equal to one minus the specified complexity, further multiplied by the search space size.

23. The computer program product of claim 19, wherein the plurality of input parameters further includes a specified complexity, and the substantially small size is substantially equal to one percent of the feasibility multiplied by a result equal to one minus the specified complexity, further multiplied by the search space size.

24. The computer program product of claim 20, wherein the substantially small size is substantially equal to one percent of the feasibility multiplied by a result equal to one minus the specified complexity, further multiplied by the search space size.

25. The computer program product of claim 21 wherein the substantially small size is substantially equal to one percent of the value.

26. A programmed computer system which is operable to select an optimization tool for solving a problem that has been sampled to determine a plurality of input parameters including a feasibility and a specified number of components, the programmed computer system being enabled to select the optimization tool by performing the steps of:
randomly creating the specified number of components having a specified minimal distance between different components within a search space, so that the components form a feasibility space having a substantially small size in relation to a search space size;
randomly enlarging the components while avoiding collisions until the feasibility space is an intermediate size that is greater than the substantially small size and less than the feasibility multiplied by the search space size;
adding complexity to the feasibility space to achieve a final size for the feasibility space that is substantially equal to the feasibility multiplied by the search space size; and
making a series of runs within the feasibility space and comparing results from the series of runs to select the optimization tool.
